(19) United States
(12) Patent Application Publication
(10) Pub. No.: US 2026/0111110 A1
(43) Pub. Date: Apr. 23, 2026

(54) ENHANCED USER INTERFACE FOR VEHICLE DISPLAYS

(71) Applicant: QUALCOMM Incorporated, San Diego, CA (US)

(72) Inventors: Ike IKIZYAN, San Diego, CA (US); Natan JACOBSON, San Diego, CA (US)

(21) Appl. No.: 18/923,473

(22) Filed: Oct. 22, 2024

(51) Int. Cl. G06F 3/04886; G06F 3/01; G06F 3/04845

(52) U.S. Cl. CPC G06F 3/04886; G06F 3/011; G06F 3/017; G06F 3/04845; G06F 2203/04803

(57) ABSTRACT

Systems and techniques are described herein for an enhanced user interface. For example, a computing device can identify a region of interest based on a first input received from a user, the first input directed at the region of interest. The computing device can adjust, on a display, elements of the user interface within the region based on the first input. The computing device can select an adjusted element within the region based on a second input received from the user and perform a function associated with the selected adjusted element.

### FIELD

The present disclosure generally relates to dynamic adjustments to user interfaces. For example, aspects of the present disclosure relate to systems and techniques for providing an enhanced user interface for vehicle displays.

### BACKGROUND

The introduction of touchscreen user interfaces (also referred to herein as touchscreens) in vehicles, such as automobiles, has introduced various safety concerns for drivers. The lack of tactile feedback from touchscreens increases a demand for eye contact to perform actions such as adjusting air-conditioning or turning on music. Touchscreens continue to be used for additional functions in operating vehicles. Many user interfaces have become overpopulated with user interface elements (e.g., icons) as manufacturers replace buttons with elements on the user interface. Safety issues are further compounded by the increasing interconnectivity between mobile devices (e.g., smartphones, tablet computers, etc.) and vehicles, resulting in numerous user interface elements populating user interfaces of touchscreens. The increased attention of user to touchscreens results in less attention to operation of a vehicle and/or the road on which the vehicle is traveling, presenting safety concerns for drivers and passengers.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for enhancing a user interface is provided. The apparatus includes at least one memory; and at least one processor coupled to the at least one memory configured to: identify a region of interest based on a first input received from a user, the first input directed at the region of interest; adjust, on a display, elements of the user interface within the region based on the first input; select an adjusted element within the region based on a second input received from the user; and perform a function associated with the selected adjusted element.

In some aspects, a method for enhancing a user interface is provided. The method includes: identifying a region of interest based on a first input received from a user, the first input directed at the region of interest; adjusting, on a display, elements of the user interface within the region based on the first input; selecting an adjusted element within the region based on a second input received from the user; and performing a function associated with the selected adjusted element.

In some aspects, a non-transitory computer-readable medium is provided having stored thereon instructions that, when executed by at least one processor, cause the at least one processor to: identify a region of interest based on a first input received from a user, the first input directed at the region of interest; adjust, on a display, elements of the user interface within the region based on the first input; select an adjusted element within the region based on a second input received from the user; and perform a function associated with the selected adjusted element.

In some aspects, an apparatus for enhancing a user interface is provided. The apparatus includes: means for identifying a region of interest based on a first input received from a user, the first input directed at the region of interest; means for adjusting, on a display, elements of the user interface within the region based on the first input; means for selecting an adjusted element within the region based on a second input received from the user; and means for performing a function associated with the selected adjusted element.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example implementation of a system-on-a-chip (SOC) in accordance with aspects of the present disclosure;

FIG. 2A is a diagram illustrating an example of a fully connected neural network, in accordance with aspects of the present disclosure;

FIG. 2B is a diagram illustrating an example of a locally connected neural network, in accordance with aspects of the present disclosure;

FIG. 2C is a diagram illustrating an example of a convolutional neural network (CNN), in accordance with aspects of the present disclosure;

FIG. 2D is a diagram illustrating an example of a deep convolutional network (DCN) for recognizing visual features from an image, in accordance with aspects of the present disclosure;

FIGS. 3A-3C are block diagrams illustrating examples of a hand tracking system for adjusting a user interface, in accordance with aspects of the present disclosure;

FIG. 4 is a block diagram illustrating an example scenario of using a hand tracking system with an inertial sensor and a machine learning model to adjust a user interface, in accordance with aspects of the present disclosure;

FIG. 5 is a flow diagram illustrating an example of a process for enhancing a user interface, in accordance with aspects of the present disclosure;

FIG. 6 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration. ” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted previously, the introduction of touchscreens into vehicles as a way for users to interact with the vehicles leads to various safety concerns. For example, such touchscreens can distract drivers from operating the vehicles and/or from paying attention to an environment of the vehicle (e.g., a road on which the vehicles are traveling, objects surrounding the vehicles, etc.). Touchscreens may lack tactile feedback that is provided by hardware buttons that are included in some vehicles. The lack of tactile feedback of touchscreens can require users to look at the touchscreen to successfully select a desired function (e.g., turning on music, controlling air conditioning, opening an application, controlling navigation settings, etc.). Diverting driver attention away from operating the vehicle and/or paying attention to the environment of the vehicle can put driver and passenger safety at risk by slowing driver reaction time.

Touchscreen user interfaces oftentimes become cluttered with user interface elements (e.g., icons) as more options are added to the user interface. For example, user interfaces have become more cluttered as interconnectivity between mobile devices (e.g., smartphones, tablet computers, etc.) and vehicles have increased. For example, a touchscreen of a vehicle can include options for controlling both the vehicle and a connected smartphone, resulting in more user interface elements being displayed on the touchscreen for selection by users. Presentation of a large number of user interface elements can further distract drivers, as the drivers must direct more attention to finding desired elements instead of focusing on operation of the vehicle and/or an environment of the vehicle.

Systems, apparatuses, electronic devices, methods (also referred to as processes), and computer-readable media (collectively referred to herein as “systems and techniques”) are described herein for providing an enhanced user interface for vehicle displays (e.g., a touchscreen interface, referred to herein as a touchscreen). The systems and techniques can include one or more hand tracking systems that can operate on sensor data from one or more sensors of a vehicle, such as images from one or more cameras of the vehicle, sensor data from one or more light detection and ranging (LIDAR) sensors of the vehicle, sensor data from one or more radio detection and ranging (RADAR) sensors of the vehicle, etc. In some aspects, the hand tracking system can be used to track user hands and fingers of a user. In some cases, the hand tracking system can track hand trajectories (e.g., motion of the hand or finger and the direction the hand or finger is headed).

In some aspects, the systems and techniques include establishing (e.g., determining, setting, etc.) a plurality of regions in front of a display (e.g., a screen, touchscreen, etc.). The systems and techniques can include adjusting user interface elements (referred to herein as elements) of a user interface based on hand location and trajectory tracked by the hand tracking system. For example, the systems and techniques can include adjusting sizes of elements of the user interface based on the location of the hand within one of the plurality of regions.

In some aspects, the systems and techniques can perform a function based on which region of the plurality of regions the hand is located. In one illustrative example, the plurality of regions can include three regions (e.g., a first region, a second region, and a third region). In some cases, the plurality of regions can include more than three regions or fewer than three regions. The first region can be a detection region. For example, when the hand enters the first region, the systems and techniques can track the hand and provide feedback to a user that the hand is being tracked. In one example, the systems and techniques can provide feedback to a user that the hand is being tracked. In some cases, the feedback can include visual feedback, such as displaying an element on the display that a hand is detected. Additionally or alternatively, in some examples, the feedback can include audio feedback, such as generating a noise to indicate the hand is detected.

In some aspects, when the hand enters the second region, the systems and techniques can determine a trajectory of the hand towards the display. In some examples, the systems and techniques can predict a region of interest of the user interface based on the trajectory or the location of the hand. The region of interest can be an area of the user interface. For example, the region of interest can include multiple elements. In some examples, the systems and techniques can adjust elements within the region of interest based on the trajectory and position of the hand. For example, elements of the user interface can be highlighted, magnified, and moved based on the trajectory and position of the hand within the second region.

In some aspects, when the hand enters the third region, the systems and techniques can predict an element from the user interface the user intends to select. The systems and techniques can adjust the predicted element, such as by magnifying the predicted element or highlighting the predicted element. The systems and techniques can receive an input from the user to select the predicted element. For example, the input can be touching an area of a touchscreen to select the predicted element. In further examples, the user can gesture to select another element instead of the predicted element.

In some aspects, the systems and techniques can receive a first input indicating a selection of a region of interest of the user interface. Based on the selection, the systems and techniques can adjust elements with the region of interest of the user interface. In some examples, the first input can be a gesture captured by the hand tracking system. In further examples, the input can be received through a touchscreen to select the region of interest of the user interface.

In some examples, the systems and techniques can reduce the size of elements from the user interface that are outside of the region of interest. The systems and techniques can select an adjusted element (e.g., a magnified element, a highlighted element, etc.) within the region of interest based on a second input received from the user. For example, the second input can include touching a touchscreen and performing a hand gesture (e.g., preset hand movement, finger movement, etc.). The systems and techniques can perform a function associated with a selected element, such as opening an application, adjusting a setting of the vehicle, adjusting a setting of the user interface, interacting or controlling a mobile device connected to the vehicle (e.g., via a wireless or wired connection), and/or other operation or function.

In some aspects, the systems can include and the techniques can utilize one or more inertial sensors, such as an inertial measurement unit (IMU), an accelerometer, a gyroscope, and/or other inertial sensor. The systems and techniques can use one or more machine learning models to predict user selections of elements based on sensor data from the one or more inertial sensors (e.g., inertial data) and user hand position or trajectory determined by the hand tracking system. In some aspects, the one or more machine learning models can include a classification model (e.g., a classification neural network), a semantic segmentation model (e.g., a semantic segmentation neural network), and/or other type of machine learning model. For instance, a machine learning model(s) can use historical inertial data (e.g., past inertial data associated with a user) to train the machine learning model. The machine learning model can adjust locations and sizes of elements of the user interface based on the inertial data. For example, the machine learning model can adjust the locations and sizes of elements to assist users attempting to select an element based on the inertial data. In another example, the inertial data can represent movements of a vehicle, such as changes in acceleration.

Various aspects of the present disclosure will be described with respect to the figures.

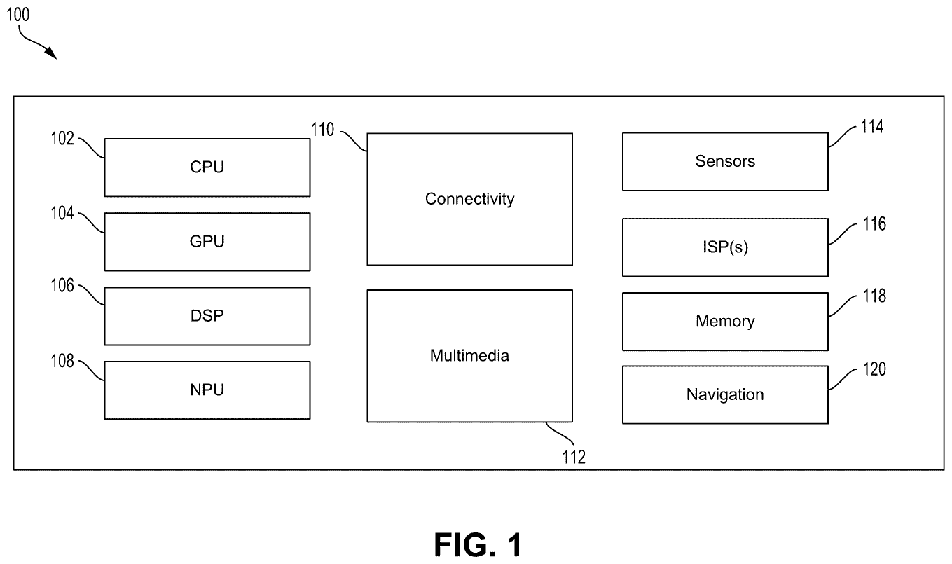

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

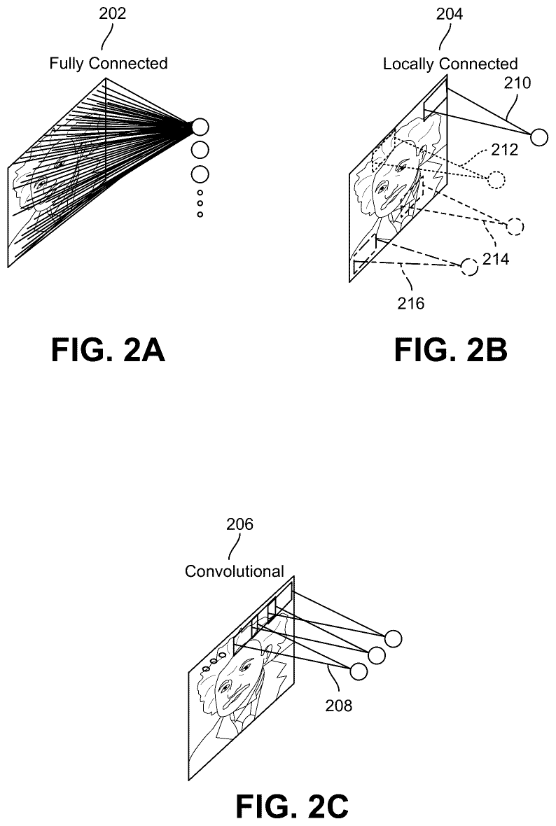

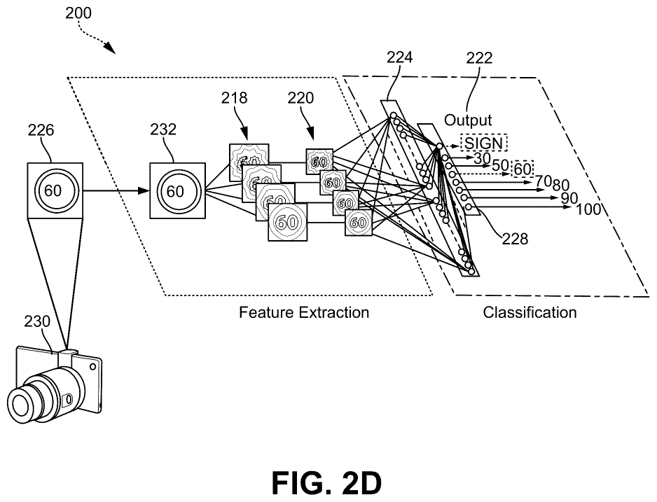

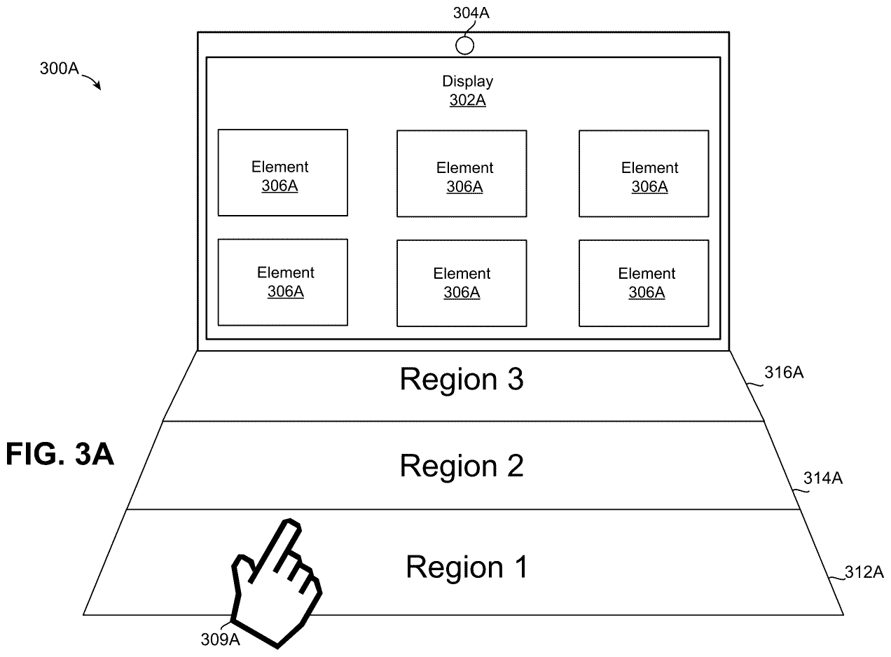

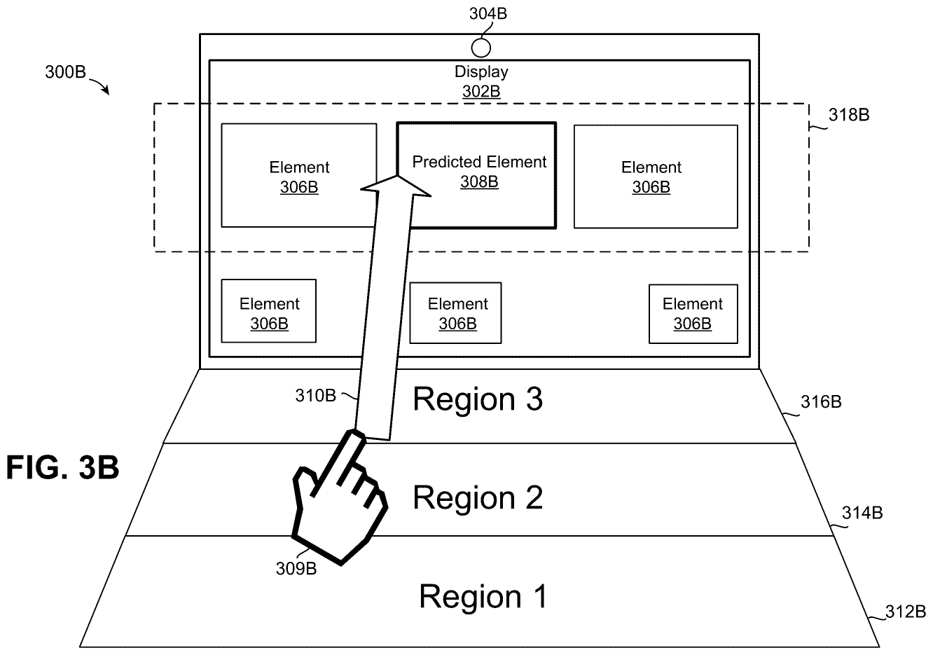

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-2D.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 328 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

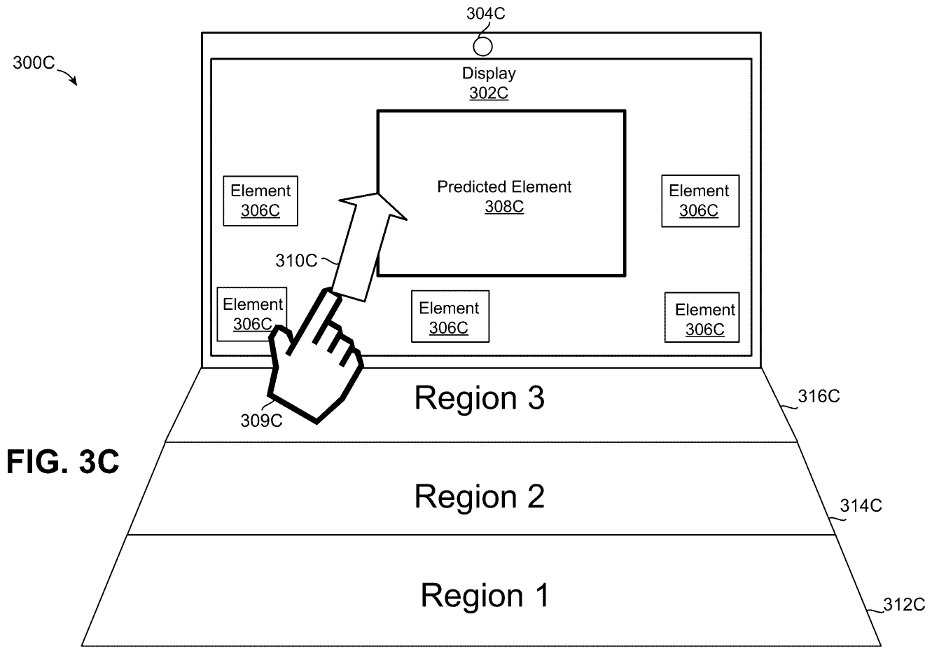

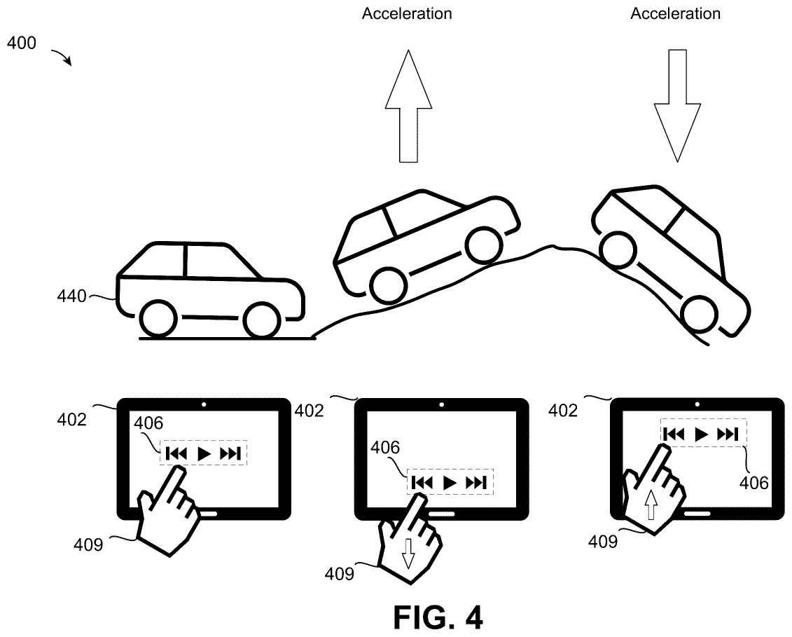

The various machine learning models described in the descriptions of FIGS. 2A-2D can be used to identify hands of a user and generate predictions of elements (e.g., icons) of a user interface the user intends to select. For example, the machine learning models can use position, trajectory, and additional sensor data (e.g., inertial data captured by an inertial measurement unit) to generate the predictions. A hand tracking system, further described in the descriptions of FIGS. 3A-3C and FIG. 4, can adjust positions and sizes of elements of a user interface based on the predictions.

FIGS. 3A-3C are block diagrams representing a hand tracking system 300A, 300B, and 300C for adjusting a user interface. The hand tracking system 300A, 300B, and 300C includes a display 302A, 302B, and 302C and a hand tracking sensor 304A, 304B, and 304C. In some examples, the display 302A, 302B, and 302C is a touchscreen. The hand tracking sensor 304A, 304B, and 304C can be a camera to track a hand 309A, 309B, and 309C in a three-dimensional (3D) space.

The hand tracking system 300A, 300B, and 300C can perform various actions based on the distance of the hand 309A, 309B, and 309C from the display 302A, 302B, and 302C. For example, FIG. 3A includes three regions representing three ranges of distances between the hand 309A and the display 302A (region 1 312A, region 2 314A, and region 3 316A). The hand tracking system 300A can begin tracking the hand 309A when it is within region 1 312A. The hand tracking system 300A can track various features of the hand 309A, such as hand position, trajectory, finger movements, gestures, etc. The hand tracking system 300A can provide feedback to a user that the hand 309A has been detected within region 1 312A. For example, the hand tracking system 300A can turn on the display 302A when the hand 309A enters region 1 312A. In further examples, the display 302A can provide visual feedback, such as highlighting an element 306A or adding an additional element to the user interface indicating the hand 309A is detected. In some examples, the hand tracking system 300A can provide auditory feedback, such as playing a noise through a speaker to indicate detection of the hand 309A.

FIG. 3B illustrates the hand tracking system 300B with the hand 309B within region 2 314B. Region 2 314B is a range of distances between region 1 312B and region 3 316B. The hand tracking system 300B can track a trajectory 310B of the hand 309B as the hand moves from region 1 312B through region 2 314B. The hand tracking system 300B predicts a region of interest 318B of a user interface based on the trajectory 310B and the position of the hand 309B. The hand tracking system 300B can enhance elements 306B within the region of interest 318B, such as by increasing size of elements, adjusting position of elements, and highlighting elements. In some examples, the hand tracking system 300B can predict an element (e.g., predicted element 308B) within the region of interest 318B a user intends to select based on the trajectory 310B and position of hand 309B. The user interface of the hand tracking system 300B can highlight the predicted element 308B to provide visual feedback to the user which element the hand tracking system 300B predicts will be selected.

In further examples, the hand tracking system 300B can reduce the size of elements 306B outside of the region of interest 318B. In some examples, the region of interest 318 can vary in size based on the position of the hand 309B within region 2 314B. For example, as the hand 309B moves closer to the display 302B, the region of interest 318 can reduce in area, such as by narrowing in width and length. In some examples, the region of interest 318 can adjust in size based on the trajectory 310B of the hand 309B. For example, the size of the region of interest 318B can become smaller when the trajectory 310B indicates the hand 309B is moving towards a corner or edge of the user interface, FIG. 3C illustrates the hand tracking system 300C with the hand 309C within region 3 316C. Region 3 316C is a range of distances closer to the display 302C than region 1 312C and region 2 314C. The hand tracking system 300C can further magnify the predicted element 308C based on the hand 309C position and trajectory 310C. For example, the predicted element 308C can increase in size or adjust position as the hand 309C moves closer to the display 302C. The hand tracking system 300A can receive a selection of an element 306C or the predicted element 308C based on a user input. For example, the display 302C can be a touchscreen and the user input can include touching the display 302C to select an element. In further examples, the user input can be a gesture of the user, such as a finger movement or hand movement. In further examples, the user can provide a gesture to the hand tracking system to adjust the elements before making a selection. In one example, a user can move his or her fingers to zoom in on an element or scroll through a menu of the user interface. For example, a user can move his or her finger in an upward direction to scroll up through options in the menu. In some examples, the hand tracking system 300C can receive the gesture by the touchscreen or the hand tracking sensor 304C.

The hand tracking system 300A, 300B, and 300C can track various inputs and gestures. For instance, when the hand tracking system 300A, 300B, and 300C is part of a vehicle, the inputs and gestures can be used to adjust settings of the vehicle or to adjust settings of an infotainment system associated with the vehicle. In one example, the hand tracking system 300A, 300B, and 300C can receive an input selecting an element associated with controlling air conditioning. The hand tracking system 300A, 300B, and 300C can track additional gestures and inputs to adjust a desired temperature of an air conditioner (e.g., swiping hand upwards to increase fan speed, swiping hand downwards to increase fan speed, etc.).

In further examples, the hand tracking system 300A, 300B, and 300C can be used to adjust a layout of the user interface. For instance, the hand tracking system can be used to adjust the size or location of elements 306A, 306B, and 306C within the user interface. In one example, elements 306A, 306B, and 306C can be associated with various applications, such as a navigation application, music application, etc. In some examples, the user can provide a gesture when his or her hand is within region 2 314B or region 3 314C to adjust the size of elements 306A, 306B, and 306C. The user interface can set the size of the elements 306A, 306B, and 306C within the user interface based on the gesture. For example, a user can set the size of the element until the hand tracking system 300A, 300B, and 300C receives another gesture to adjust the size of the element.

In some examples, the hand tracking system 300A, 300B, and 300C do not distinguish between regions. For example, the hand tracking system 300A, 300B, and 300C can adjust the size and position of elements 306A, 306B, and 306C based on a linear or non-linear relationship between the position of the hand 309A, 309B, and 309C and the display 302A, 302B, and 302C.

In further examples, the hand tracking system 300A, 300B, and 300C can determine trajectory 310B and 310C of the hand 309B and 309C by identifying a reference point of the hand (e.g., the tip of an index finger) from an image. The hand tracking system can track an x-coordinate and y-coordinate position of the reference point relative to the display 302B and 302C as the hand moves. In some examples, the hand tracking system can perform various image processing techniques to determine the location of the reference point in a z-coordinate position, where the z-coordinate position is orthogonal to the display 302A, 302B, and 302C.

For example, the hand tracking system 300A, 300B, and 300C can track the hand 309A of a user using a machine learning model, such as the machine learning models described in the description of FIGS. 2A-2D. For example, the machine learning model can be trained to identify a hand from images captured by the hand tracking sensor (e.g., 304A, 304B, and 304C), and predict an element (e.g., predicted element 308B and 308C) based on position and trajectory of the hand.

In one example, the machine learning model can be trained to perform various image processing techniques to identify the x-coordinate, y-coordinate, and z-coordinate of a reference point of the hand 309A, 309B, and 309C. For example, the machine learning model can be trained to perform monocular depth estimation on images to determine a relative z-coordinate location of the reference point. In further examples, the hand tracking sensor 304A, 304B, and 304C can include a plurality of cameras. The machine learning model can determine a z-coordinate of the reference point based on a comparison of multiple images captured by the plurality of cameras (e.g., two or more images from cameras at different perspective angles). The machine learning model can perform various other stereo vision techniques such as block matching of pixels between multiple images.

In further examples, the hand tracking sensor 304A, 304B, and 304C can include a camera and a ranging sensor, such as a time-of-flight (ToF) sensor, infrared (IR) sensor, RADAR sensor, and LIDAR sensor. The machine learning model can determine an x-coordinate and y-coordinate of the hand 309A, 309B, and 309C and determine the z-coordinate based on the range sensor.

In some aspects, training of one or more of the machine learning systems or neural networks described herein (e.g., such as the neural networks of FIGS. 2A-2D, among various other machine learning networks described herein) can be performed using online training (e.g., in some case on-device training), offline training, and/or various combinations of online and offline training. In some cases, online can refer to time periods during which the input data (e.g., such as the sensor data, images, masks) is processed, for example for performance of optimizing loss weights of the loss function to reduce losses while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 4 is a block diagram illustrating an example scenario 400 of using a hand tracking system with an inertial sensor (e.g., an inertial measurement unit (IMU), accelerometer, gyroscope, etc.) and machine learning model to adjust elements of a user interface. The example scenario 400 includes a hand tracking system 402, such as the hand tracking system 300A, 300B, and 300C from FIGS. 3A-3C. The hand tracking system 402 is integrated into a vehicle 440. The hand tracking system 402 includes a display for displaying a user interface. For example, the hand tracking system 402 can be part of an infotainment system of the vehicle 440.

The hand tracking system 402 includes an inertial sensor, such as an accelerometer, gyroscope, etc. The inertial sensor collects inertial data associated with movements of the vehicle 440. For example, the inertial sensor can collect inertial data related to movements of the vehicle across different terrains, grades (e.g., slopes), and changes in vehicle acceleration. The hand tracking system 402 can include a hand tracking sensor, such as a camera, to track movements of a hand 409 of a user. The machine learning model receives the inertial data and sensor data from the hand tracking sensor to predict how movements of the vehicle 440 adjusts position and trajectory of the hand 409. The machine learning model can adjust the position of elements 406 on a user interface based on the prediction. For example, the machine learning model can move one or more elements to different locations within the user interface (e.g., shifting elements up, down, left, right, etc.) based on the prediction. In some examples, the machine learning model can move multiple elements. In some examples, the machine learning model can move an element the machine learning model predicts the user intends to select.

In further examples, when a user attempts to make a selection while the vehicle 440 accelerates in an upward direction (e.g., when going up a hill or speed bump), the machine learning model can predict the elements 406 should shift to a lower position on the user interface. In another example, when the user attempts to make a selection while the vehicle 440 accelerates in a downward direction (e.g., when going down a hill), the machine learning model can shift the elements 406 upwards.

In further examples, the machine learning model can predict an intended position of the hand of the user. The machine learning model can predict the intended position of the hand based on movement of the hand resulting from a movement of the vehicle represented in the inertial data. For example, when the vehicle accelerates in an upwards direction resulting in the hand moving downwards when selecting an element, the machine learning model can predict that the user intended to select a different element based on the inertial data.

In some examples, the machine learning model can be trained on historical inertial data and historical sensor data (e.g., inertial data and sensor data from prior scenarios where the user attempted to select an element 406 while the vehicle accelerates). For example, training can include comparing historical inertial data and historical sensor data to identify where the hand of the user was shifted in response to movements represented in the historical inertial data. The training process can include calculating error between where the hand shifted and an intended position of the hand. Weights of the machine learning model can be adjusted so that the output of the machine learning model (e.g., position of the elements 406) more closely aligns with the target output (e.g., an intended position of the hand).

In further examples, the hand tracking system 402 can use a machine learning model trained on historical inertial data and historical sensor data of a user. For example, the hand tracking system 402 can include profiles for different users trained on historical inertial data and historical sensor data associated with each of the respective different users. In one example, users can select a user profile. In further examples, the hand tracking system 402 can identify a user and select a user profile. For example, the hand tracking system 402 can be part of an infotainment system of the vehicle 440. In such an example, the hand tracking system 402 can identify the user based on pairing an electronic device (e.g., a smartphone) to the infotainment system. The hand tracking system 402 can associate the electronic device with a user profile.

In further examples, the hand tracking system 402 can identify a user based on the hand tracking sensor. For example, the hand tracking sensor can be a camera. In some examples the hand tracking system can use the camera to perform various recognition techniques to identify a user (e.g., facial recognition). In further examples, users can select a profile when using the hand tracking system 402 such as by selecting the profile on the user interface.

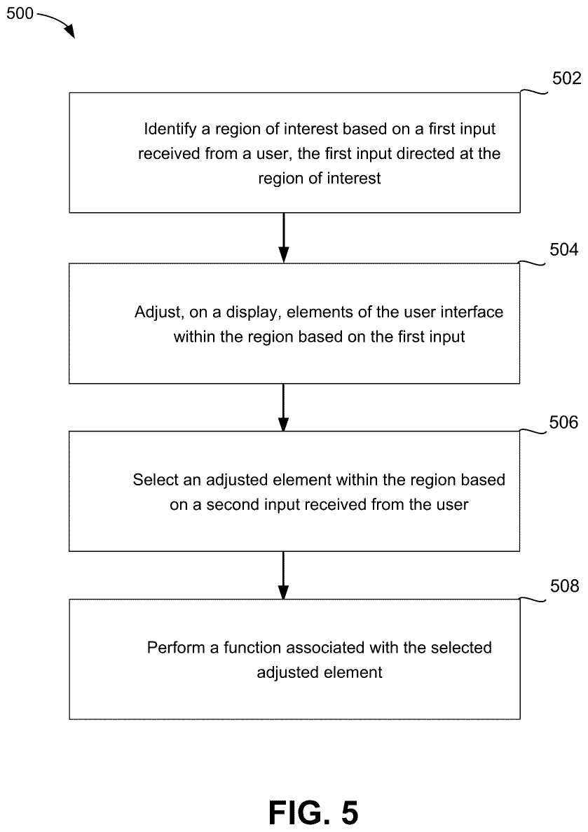

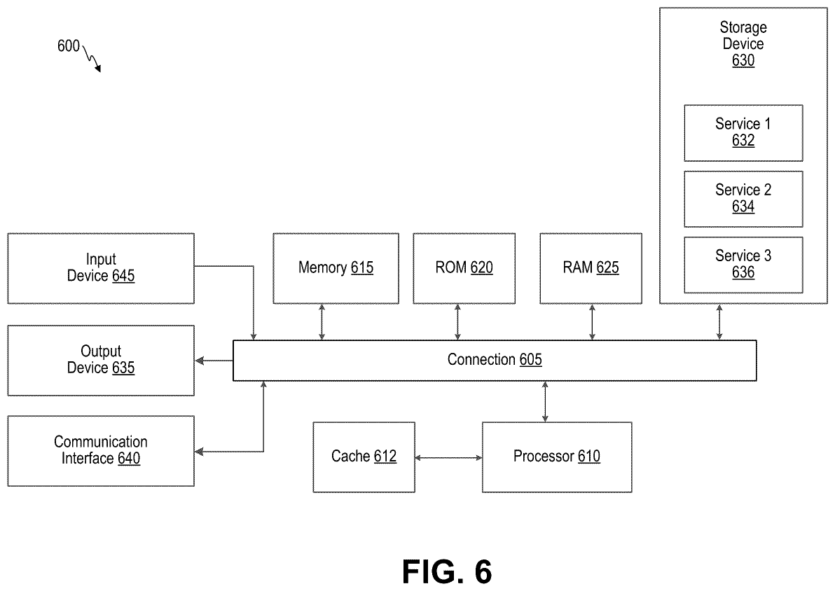

FIG. 5 is a flow diagram illustrating an example of a process 500 for adjusting a user interface using a hand tracking system. The process 500 can be performed by a computing device (e.g., SOC 100 of FIG. 1, computing device or computing system 600 of FIG. 6, etc.) or by a component or system (e.g., the neural networks of FIGS. 2A-2D, a chipset, one or more processors central processing units (CPUs), digital signal processors (DSPs), graphics processing units (GPUs), any other type of processor(s), any combination thereof, or other component or system) of the computing device. The operations of the process 500 can be implemented as software components that are executed and run on one or more processors (e.g., processor 610 of FIG. 6 or other processor(s)) of the computing device. Further, the transmission and reception of signals by the computing device in the process 500 can be enabled, for example, by one or more antennas and/or one or more transceivers (e.g., wireless transceiver(s)).

At block 502, the computing device (or component thereof) can identify a region of interest based on a first input received from a user, the first input directed at the region of interest. The region of interest can be a region of interest (e.g., an area) associated with a display or user interface. For example, the region of interest can be a corner of the display or the user interface. In some examples, the first input is a tap of a finger on a touchscreen. In further examples, the first input is a gesture, such as a movement of a hand.

In further examples, the computing device includes a camera or other optical sensor that can operate as a hand tracking system. For example, the computing device (or component thereof) can use the hand tracking system to detect a hand. The first input can be a trajectory and position of the hand towards the region of interest of the display or user interface.

At block 504, the computing device (or component thereof) can adjust, on a display, elements of the user interface within the region based on the first input. Adjustments to the elements can include highlighting elements, enhancing elements (e.g., magnifying the elements on the screen by increasing the size of the elements), and adjusting position of the elements on the display or user interface. For example, the computing device (or component thereof) can adjust the size and position of elements of a user interface based on the first input (e.g., a hand trajectory, hand position, gesture, etc.).

At block 506, the computing device (or component thereof) can select an adjusted element within the region based on a second input received from the user. For example, the second input can be a tapping the adjusted element on a touchscreen. In another example, the second input can be a gesture, such as moving a hand or finger.

At block 508, the computing device (or component thereof) can perform a function associated with the selected adjusted element. For example, the function can be opening an application associated with the selected adjusted element. In another example, the function can be adjusting a setting of the user interface (e.g., adjusting position of elements of the user interface, adjusting color scheme of the user interface, adjusting size of elements of the user interface, etc.) or adjusting a setting associated with a vehicle (e.g., turning on lights, turning on radio, displaying tire pressure, etc.)

FIG. 6 is a diagram illustrating an example of a system for implementing certain aspects of the present technology. In particular, FIG. 6 illustrates an example of computing system 600, which can be for example any computing device making up internal computing system, a remote computing system, a camera, or any component thereof in which the components of the system are in communication with each other using connection 605. Connection 605 can be a physical connection using a bus, or a direct connection into processor 610, such as in a chipset architecture. Connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 600 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 600 also includes a connection 605 that couples various system components including system memory 615, such as read-only memory (ROM) 620 and random-access memory (RAM) 625 to processor 610. Computing system 600 can include a cache 612 of high-speed memory connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 can essentially be a completely self-contained computing system, containing multiple cores or processors, a bus, memory controller, cache, etc. A multi-core processor can be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms. In some instances, multimodal systems can enable a user to provide multiple types of input/output to communicate with computing system 600. Computing system 600 can include communications interface 640, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 can also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc. When the code that defines such software is executed by the processor 610, the code causes the system to perform a function. In some aspects, a hardware service that performs a particular function can include the software component stored in a computer-readable medium in connection with the necessary hardware components, such as processor 610, connection 605, output device 635, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for enhancing a user interface, the apparatus comprising: at least one memory; and at least one processor coupled to the at least one memory configured to: identify a region of interest based on a first input received from a user, the first input directed at the region of interest; adjust, on a display, elements of the user interface within the region based on the first input; select an adjusted element within the region based on a second input received from the user; and perform a function associated with the selected adjusted element.

Aspect 2: The apparatus of Aspect 1, wherein the at least one processor is configured to track a position of a hand across a first region, a second region, and a third region.

Aspect 3: The apparatus of Aspect 2, wherein the at least one processor is configured to track the position of the hand using a hand tracking system.

Aspect 4: The apparatus of Aspect 3, wherein the at least one processor is configured to: determine the position of the hand is within the first region; and in response to a determination that the position of the hand is within the first region, output, via the user interface, visual feedback indicating that the hand tracking system detects the hand.

Aspect 5: The apparatus of any of Aspects 3 to 4, wherein the at least one processor is configured to: determine the position of the hand is within the second region; and in response to a determination that the position of the hand is within the second region, adjust the elements of the user interface within the region.

Aspect 6: The apparatus of any of Aspects 3 to 5, wherein the at least one processor is configured to: determine the position of the hand is within the third region; and in response to a determination that the position of the hand is within the third region, the at least one processor is configured to select the adjusted element within the region.

Aspect 7: The apparatus of any of Aspects 1 to 6, wherein the at least one processor is configured to increase sizes of the elements as a hand approaches the display.

Aspect 8: The apparatus of any of Aspects 1 to 7, wherein the first input includes a trajectory of a hand.

Aspect 9: The apparatus of any of Aspects 1 to 8, wherein the second input is a hand gesture.

Aspect 10: The apparatus of Aspects 1 to 9, wherein the apparatus further comprises an inertial sensor, and wherein the at least one processor is configured to: adjust positions of the elements on the display based on inertial data from the inertial sensor.

Aspect 11: The apparatus of Aspect 10, wherein the at least one processor is configured to: adjust the positions of the elements using a machine learning model, wherein the machine learning model is trained using historical inertial data and historical hand position data.

Aspect 12: The apparatus of Aspect 11, wherein the machine learning model is trained using on-device training.

Aspect 13: The apparatus of Aspect 12, wherein the first input is a finger gesture on a touchscreen.

Aspect 14: The apparatus of any of Aspects 1 to 13, wherein, to perform the function, the at least one processor is configured to open an application associated with the selected adjusted element, adjust a setting of the user interface, or adjust a setting associated with a vehicle.

Aspect 15: The apparatus of any of Aspects 1 to 14, wherein the at least one processor is configured to: decrease a size of the adjusted elements after receiving the second input.

Aspect 16: A method for enhancing a user interface, the method comprising: identifying a region of interest based on a first input received from a user, the first input directed at the region of interest; adjusting, on a display, elements of the user interface within the region based on the first input; selecting an adjusted element within the region based on a second input received from the user; and performing a function associated with the selected adjusted element.

Aspect 17: The method of Aspect 16, further comprising: tracking a position of a hand across a first region, a second region, and a third region.

Aspect 18: The method of Aspect 17, wherein tracking the position of the hand is tracked using a hand tracking system.

Aspect 19: The method of Aspect 18, further comprising: determining the position of the hand is within the first region; and outputting, via the user interface, visual feedback indicating that the hand tracking system detects the hand in response to a determination that the position of the hand is within the first region.

Aspect 20: The method of any of Aspects 18 to 19, further comprising: determining the position of the hand is within the second region; and adjusting the elements of the user interface within the region in response to a determination that the position of the hand is within the second region.

Aspect 21: The method of any of Aspects 18 to 20, further comprising: determining the position of the hand is within the third region; and selecting the adjusted element within the region in response to a determination that the position of the hand is within the third region.

Aspect 22: The method of any of Aspects 16 to 21, further comprising: increasing sizes of the elements as a hand approaches the display.

Aspect 23: The method of any of Aspects 16 to 22, wherein the first input includes a trajectory of a hand.

Aspect 24: The method of any of Aspects 16 to 23, wherein the second input is a hand gesture.

Aspect 25: The method of any of Aspects 16 to 24, further comprising: adjusting positions of the elements on the display based on inertial data from an inertial sensor.

Aspect 26: The method of Aspect 25, further comprising: adjusting the positions of the elements using a machine learning model, wherein the machine learning model is trained using historical inertial data and historical hand position data.

Aspect 27: The method of Aspect 26, wherein the machine learning model is trained using on-device training.

Aspect 28: The method of Aspect 27, wherein the first input is a finger gesture on a touchscreen.

Aspect 29: The method of any of Aspects 16 to 28, wherein, to perform the function, the method includes: opening an application associated with the selected adjusted element, adjust a setting of the user interface, or adjust a setting associated with a vehicle.

Aspect 30: The method of any of Aspects 16 to 29, further comprising: decreasing a size of the adjusted elements after receiving the second input.

Aspect 31: A non-transitory computer-readable medium is provided having stored thereon instructions that, when executed by at least one processor, cause the at least one processor to perform operations according to any of Aspects 16 to 30.

Aspect 32: An apparatus for enhancing a user interface is provided. The apparatus includes one or more means for performing operations according to any of Aspects 16 to 30.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for enhancing a user interface, the apparatus comprising:
at least one memory; and
at least one processor coupled to the at least one memory configured to:
identify a region of interest based on a first input received from a user, the first input directed at the region of interest;
adjust, on a display, elements of the user interface within the region based on the first input;
select an adjusted element within the region based on a second input received from the user; and
perform a function associated with the selected adjusted element.

2. The apparatus of claim 1, wherein the at least one processor is configured to track a position of a hand across a first region, a second region, and a third region.

3. The apparatus of claim 2, wherein the at least one processor is configured to track the position of the hand using a hand tracking system.

4. The apparatus of claim 3, wherein the at least one processor is configured to:
determine the position of the hand is within the first region; and
in response to a determination that the position of the hand is within the first region, output, via the user interface, visual feedback indicating that the hand tracking system detects the hand.

5. The apparatus of claim 3, wherein the at least one processor is configured to:
determine the position of the hand is within the second region; and
in response to a determination that the position of the hand is within the second region, adjust the elements of the user interface within the region.

6. The apparatus of claim 3, wherein the at least one processor is configured to:
determine the position of the hand is within the third region; and
in response to a determination that the position of the hand is within the third region, the at least one processor is configured to select the adjusted element within the region.

7. The apparatus of claim 1, wherein the at least one processor is configured to increase sizes of the elements as a hand approaches the display.

8. The apparatus of claim 1, wherein the first input includes a trajectory of a hand.

9. The apparatus of claim 1, wherein the second input is a hand gesture.

10. The apparatus of claim 1, wherein the apparatus further comprises an inertial sensor, and wherein the at least one processor is configured to:
adjust positions of the elements on the display based on inertial data from the inertial sensor.

11. The apparatus of claim 10, wherein the at least one processor is configured to:
adjust the positions of the elements using a machine learning model, wherein the machine learning model is trained using historical inertial data and historical hand position data.

12. The apparatus of claim 11, wherein the machine learning model is trained using on-device training.

13. The apparatus of claim 1, wherein the first input is a finger gesture on a touchscreen.

14. The apparatus of claim 1, wherein, to perform the function, the at least one processor is configured to open an application associated with the selected adjusted element, adjust a setting of the user interface, or adjust a setting associated with a vehicle.

15. The apparatus of claim 1, wherein the at least one processor is configured to:
decrease a size of the adjusted elements after receiving the second input.

16. A method for enhancing a user interface, the method comprising:
identifying a region of interest based on a first input received from a user, the first input directed at the region of interest;
adjusting, on a display, elements of the user interface within the region based on the first input;
selecting an adjusted element within the region based on a second input received from the user; and
performing a function associated with the selected adjusted element.

17. The method of claim 16, further comprising:
determining a position of a hand is within a first region; and
outputting, via the user interface, visual feedback indicating that a hand tracking system detects the hand in response to a determination that the position of the hand is within the first region.

18. The method of claim 17, further comprising:
determining the position of the hand is within a second region; and
adjusting the elements of the user interface within the region in response to a determination that the position of the hand is within the second region.

19. The method of claim 18, further comprising:
determining the position of the hand is within a third region; and
selecting the adjusted element within the region in response to a determination that the position of the hand is within the third region.

20. A non-transitory computer readable medium storing code for enhancing a user interface, the code comprising instructions executable by a processor to:
identify a region of interest based on a first input received from a user, the first input directed at the region of interest;
adjust, on a display, elements of the user interface within the region based on the first input;
select an adjusted element within the region based on a second input received from the user; and
perform a function associated with the selected adjusted element.
